(19) United States
(12) Patent Application Publication
(10) Pub. No.: US 2015/0170518 A1
(43) Pub. Date: Jun. 18, 2015

(54) ELECTRONIC SYSTEM FOR AUTHORIZATION AND SEARCH FOR PARKING SPACES

(71) Applicant: Irazú I. RODRÍGUEZ GARZA, (US)

(72) Inventor: Irazú I. Rodríguez Garza, Monterrey (MX)

(21) Appl. No.: 14/415,904

(22) PCT Filed: Oct. 26, 2012
(86) PCT No.: PCT/MX2012/000107

§ 371 Date: Jan. 20, 2015

(30) Foreign Application Priority Data
Jul. 18, 2012 (MX) MX/A/2012/008368

(51) Int. Cl. G08G 1/14

(52) U.S. Cl. CPC G08G 1/144

(57) ABSTRACT

A wireless electronic system for the authorization of parking time, search and monitoring of available parking spaces for vehicles in real-time and in a plurality of areas, comprising: a user, who drives the vehicle to be parked in an available space under authorization, wherein the user carries a portable wireless communication device for receiving reports and/or making requests to the system; a server, wherein there is a database where the information corresponding to each user and each parked vehicle recorded in the system is concentrated, wherein said server shares information with the other elements of the system through compatible wireless communication media; an electronic device installed in each vehicle, wherein said device can calculate, in real-time, the geographical location of said vehicle to process such information, change its status and to report it wirelessly to the user, server and/or any parking system of the prior art, wherein said electronic device interacts with its immediate ambient through outputs that indicate its current status on site and inputs to receive user requests; one or a plurality of systems of the prior art, adapted to be compatible with the system, wherein such prior art systems send and receive information concerning the number of vehicles that are parked in its working area, as well as the status of each vehicle.

### FIELD OF THE INVENTION

This invention refers to a global or partial electronic parking system, configured for wireless and real-time management of parking spaces available in any area, such that the users and the service provider, which is usually a municipality or authority, have control and monitoring of the service in order to give authorization and search service for available parking spaces so that users can park in a certain area. The system includes one or a plurality of users, a provider of service, optionally a system of parking of the prior art and an electronic device mounted in a vehicle that has a wireless communication unit, a satellite geographic location unit, a controller unit, a general input/output unit and optionally a RFID unit and a Bluetooth unit. The invention is applicable to all vehicles.

### BACKGROUND OF THE INVENTION

Parking industry or public or private parking service, which are normally administered by a municipality, Government or private company, provides comfort, safety and convenience features to people who drive a car or vehicle, which can be motorized, within a city normally overcrowded or with high rates of population per square meter, where it is common to find intense vehicle traffic in important avenues or in commercially, touristically, historically or habitationally recognized public areas, so it is also difficult to find a parking space in these areas, which is frustrating for the user in case of hurry, resulting in a pollution problem and, at the same time, losses of time and money for the society and stress for the user. Many users, driving in their cars, try to find themselves a parking place available in streets adjacent or close to the area they seeking to visit, because this reduces the time and cost required to find the parking space or simply deletes them. This causes a disorder or lack of coordination and, at the same time, affects the residents of these nearby areas by the saturation of cars around their homes, where these cars or vehicles are not paying for the use of the utilized parking space, or pay a lower rate, so said residents require such vehicles to remain parked a reasonable time, as soon as possible or that somehow can be benefit by such impact in their area with better services, image, appreciation, etc.

The types of vehicles can be compact cars, vans, trucks, buses, motorcycles, bicycles, or any other means used for the transportation of something or someone and, at the same time, require parking or position in an appropriate place when such transportation is complete or reaches its destination.

One of the parking systems already deployed in the prior art is the system commonly known as parking meter, which has a plurality of embodiments depending on the service provider, the place where it is implemented, the cost of installation, the cost for the user, etc. which, however, basically refers to a system in which the vehicle is parked in a certain previously conditioned place in order to park a car. This conditioning refers to the size of the place in its length and width dimensions such that a vehicle may park without difficulty, as well as the installation of the corresponding measurement devices. These parking meter systems known in the prior art are installed near or next to the site where the parking space is assigned for the vehicle, where once the vehicle is parked, said device records the time and/or the period in which the vehicle was parked, and where the user performs a prepayment or deposits some bonus which can be a monetary amount to obtain authorized time or a temporary permit for using the parking space without receiving a penalty. The fee for the parking space is based on a pre-set rate that usually depends on the parking time. Once the car is parked and the prepayment or bonus is made, the system will deduct the corresponding fees to the prepaid monetary amount as the time passes in which the vehicle continues parked, having a limit to reduce such a prepayment or deposit, where if the time runs out and if the user needs more parking time, the user has to move back to the place where the vehicle is parked to make said deposit or prepayment by the remaining estimated time. In the same manner, if the user decides to retire before prepayment or bonus is consumed, the time remaining, in the best of cases, will be used by another user or is simply wasted. The device that records the start time of vehicle parking is usually an electromechanical apparatus which is positioned on one side of the parking space or at the curb, where coins are deposited, which results in a device for each parking place, so that for each parking system of parking meters of prior art, a plurality of units equal to the number of available parking spaces is required. The installation of these devices involves various direct and indirect costs, where exists a requirement of providing power to devices and the communication media with other monitoring devices or stations, as well as civil engineering and corresponding maintenance. These devices also create a visual pollution by saturating the sidewalks and streets of a city. In addition, these devices have been subject of vandalism and constant failures. An operator or supervisor of the parking system has to move constantly to each device in order to empty its box of coins, in order to avoid saturation or jamming of said device. Another disadvantage is the discomfort to the user by the fact of depositing coins each time that the period is about to run out, which causes a nuisance and loss of time to the user, since sometimes the user does not carry ready cash and also it is possible that the user is exposed to an inclement weather in this process. This system does not help the user to easily locate a parking space, but it is limited to measure times and charge for those times of vehicle parking.

There is another parking meter system where instead of using an electromechanical device for each parking space, i.e., a plurality of devices for each parking space in a street or area, a kind of administering and payment kiosk or window for every street is used. The kiosk or window can also be other electromechanical device. This method was able to reduce many costs of operation, maintenance and reduce visual pollution, however, remain the mentioned disadvantages. In addition, the type of payment is also similar, where the user has to be physically present to make the payment, which can result in a loss of time, a problem and/or a disadvantage in case of any inclement weather, such as rain or snowfall where, in the same way, can be unsafe and uncomfortable for that user.

Many parking systems have attempted to solve many of the disadvantages present in the prior art. Such is the case of U.S. Pat. No. 6,5193,29, which helps the user to start and end the cycle of parking by phone, where the payment method is facilitated by relating a plastic card with credits for payment or through user-related identification codes. However, it is necessary that the user makes calls to start or end a cycle, and memorizing a code or constantly carrying an ID card is not secure for all users. In addition, this system is useful only in closed parking lots that are related to said system, and where control and management are limited.

A particular model for open parking spaces, such as streets or avenues where parking vehicles is allowed, and based on the system of parking meters, is the Patent Application US 2012/0078686 A1, which creates virtual representations of a street based on GPS technology, images and sensors, where automobiles can be parked, such that the user of the visualization system, who represents an authority and on the basis of an identification of the vehicle, usually the vehicle plate, knows if the vehicle driver has paid or not its parking time or if this time already ran out, in which case a penalty is applied. However, this system fails to overcome the disadvantages described from the point of view of customer or the car that is parked, but from the point of view of the supervisor and/or authority who will monitor the status of every car parked on an image with virtual traits.

The Patent Application US 2007/005224 A1, refers to a system of monitoring traffic with the embodiment of facilitating the user to find a parking space during a movement and also the user is informed about existing traffic in other avenues, where a plurality of stations for monitoring is used. The way in which the parking space is determined is not related to any previous installed parking system, which may cause conflicts. In the same manner, it only exceeds certain previously described disadvantages from the point of view of the user, but not from the point of view of the manager or the authority.

In the same manner, the U.S. Pat. No. 6,694,259 tries to solve several of the problems found in a parking system by making use of computer image analysis to identify empty or occupied spaces in a parking lot, however, it requires the use of a plurality of cameras, which involves a high initial investment. It is also applicable to closed parking lots.

For these reasons, it is necessary to devise a parking system that replaces the system of parking meters and that resolves the disadvantages mentioned above from the point of view of the customer or user and from the point of view of the service provider and/or the authority responsible for monitoring, punishing and/or managing, which may be a private company in coordination with the municipality in the area, or the corresponding government, so that this system requires lower maintenance costs, provides order and coordination in the working areas, offers varying parking rates according to the area or schedule, location of the vehicle in real-time, integration with existing systems of parking of the prior art, and the possibility of progressive extension, replacing gradually all of these state of the art systems, without affecting users or the daily life in the city. In the present invention, the user has the ability to pay or deposit bonus for a parking time in a parking place or space that can be located from his mobile device of wireless communication, such as a smart phone or mobile phone, configured to be identified by the system of the present invention, resulting in quickness and convenience for the user. The system of the present invention is intended to use with only one, with a plurality, or with all vehicles that circulate in a given area so that these cars find a private or public parking space, whether open or closed, in a quick, expedited, simple and friendly way for the user where, at the same time, an order and coordination are established in areas that lack of parking systems, but where, however, vehicles are parked. All of the preceding aspects are configured in an electronic, wireless and real-time way.

### SUMMARY OF THE INVENTION

The present invention relates to an electronic system to authorize parking time, by means of a mobile or smart phone, for one or a plurality of users who park their vehicles in a public or private, open or closed, parking lot, and which can be any avenue or street of a city or area. This system resolves the disadvantages found in the prior art relating to parking systems that use the model of parking meter to make bills and measure times, and it also solves the problems of order and coordination in areas where no parking system is implemented. The characteristics of the system of the present invention make it possible to reduce operative and maintenance costs, and facilitate the management of the service by the service provider. In addition, they facilitate and make transparent the payment performed by the user and remove the visual pollution in the streets and avenues due to electromechanical devices used to receive payments of parking time used in the state of the art.

The system comprises a user, a server, an electronic device fixed in a car, optionally a parking kiosk or system of the prior art, and also optionally a portable electronic device that will be carried by any authority or operator.

The user is the person who owns or drives the vehicle that is intended to park. The fixed electronic device is the apparatus that measures the parking time and determines the geographical location, by geographical coordinates in real-time, of the vehicle when said vehicle is parked or circulating in a certain area. The server is the database which concentrates the characteristic information on each user and/or each electronic device, wherein said server is managed by the service provider. This system is designed such that each vehicle, from a plurality or entirety of vehicles, counts with a fixed electronic device properly installed in the vehicle. The fixed electronic device is provided to the user by the service provider, either by purchase, rent or loan.

The electronic device has a GSM communication module, a GPS module, a module of general or digital inputs and outputs, and a driver or main module that controls all modules or units that comprise the electronic device. Optionally, this electronic device also comprises an RFID module to quickly and easily identify such a fixed electronic device, and a Bluetooth module for the exchange of information with other nearby compatible devices.

The electronic device is installed within the car or vehicle, with any of its modules to the sight and touch of the user, so that the user interacts with said device. The user drives and moves in the vehicle with the electronic device knowing, in real-time, the geographic location of the vehicle. When the user decides to look for a parking space, he looks at the status of the electronic device in order to be informed in real-time if he has authorization to park in a certain area. A positive authorization means that the user has previously made a prepayment, deposit, and/or bonus, or has a credit for this service, in such a way that, previously or not previously to a request, he is authorized to park in the area in which is located. A negative authorization means that the user does not have sufficient privileges to park in the corresponding or current area, so he will need to send a request to the server, which may be a text message, a message over the Internet or any other means, using his smart phone or mobile phone, asking for a certain amount of time, where the server identifies the phone number from where this message comes, so that it performs the corresponding charge for this amount of time to the corresponding user. The time asked for or requested by the user is charged through the account that the user maintains with its service of mobile or cellular phone, which at the same time is related to the service provider of the present invention, such that at the end of the month or the cutoff date, he will receive the statement of account of its telephone service with details of parked time and/or the exact location.

Once parked the vehicle, the operating cycle starts, so that the authorized time begins to be deducted as time passes. The user can be anywhere else carrying out his activities while his vehicle is properly parked, since inside is an electronic device that is constantly locating and measuring the time used. At the time that the authorized time is about to run out, a message is sent to the user to inform him on the new state of his vehicle, so that the user, in a response communication, may request to the server (or service provider) more time parking, which will be granted automatically and loaded or recorded in order to be paid later through the phone bill previously mentioned. Once authorized this time of parking, the electronic device is notified to update its status and records. If the user does not request more time parking and this time runs out, then the electronic device will emit a sound or visual signal such that any operator and/or authority that is in the area, such as a policeman, identifies easily this signal and take appropriate measures applicable, such as a penalty or fine for the user, since if his car is parked in a street, avenue or parking lot without paying the time used or corresponding rate, and where the policeman, in order to easily identify the user of the vehicle, will carry a portable electronic device that has a RFID reader which, once approximated to the vehicle, reads the corresponding information through the RFID module (optional) built into the electronic device, and also sends the relevant information in order to apply the penalty. The service provider may be a public or private company, where those who normally manage available parking spaces are the municipalities or the state administrations, so that these municipalities or the state authorities may be the service providers.

Since this system can know the status and location of a plurality of vehicles in a certain area at a given time, and under a previous analysis of how many vehicles approximately fit in each area, street or parking lot, the system can realize if there are available parking spaces in the area, street or parking lot, so that the user can be informed, through a text message or any type of instant communication, about the availability of nearby parking spaces and its location by geographic coordinates and/or street name, distance, etc. This message about the geographical location by geographical coordinates is also sent to the electronic device, such that it can interact with any commercially available satellite navigation equipment. That is, using the optional Bluetooth module, it can be linked through Bluetooth to the electronic device of the system of the present invention, which already knows the geographic coordinates of the available parking space, since the system reported it, with any equipment of satellite navigation through GPS of any compatible provider, which, once knowing the destination information, since the geographic coordinates are transmitted by the electronic device, guides step by step the user to the destination or parking space identified by the system of the present application. It is also possible that, upon a request from the user, the system can reserve for a limited time, specified or unspecified, an available parking space for that user, so that, within this given time, the system will not offer it to other user and, in addition, the fixed electronic device of some other user may emit a signal to inform that the parking space is reserved when said another user is in the vicinity.

Furthermore, an optional embodiment of the present invention is for an alarm system for the parked vehicle, where several corresponding sensors can be attached to the electronic device such that it emits and transmits an alarm before any disturbance of these sensors. In the same manner, when the user is carrying out his activities and the operating cycle of the system is not finished, the alarm can be emitted when the vehicle is changed in location, and this change of geographical location is known using the GPS built into the electronic device.

### BRIEF DESCRIPTION OF THE DRAWINGS

FIG. 1 shows the elements of the system of the present invention.

FIG. 2 shows the units comprising the electronic device of the present invention.

FIG. 3 shows a method of operation of the present invention.

FIG. 4 shows an embodiment of a portion of the working method in FIG. 3.

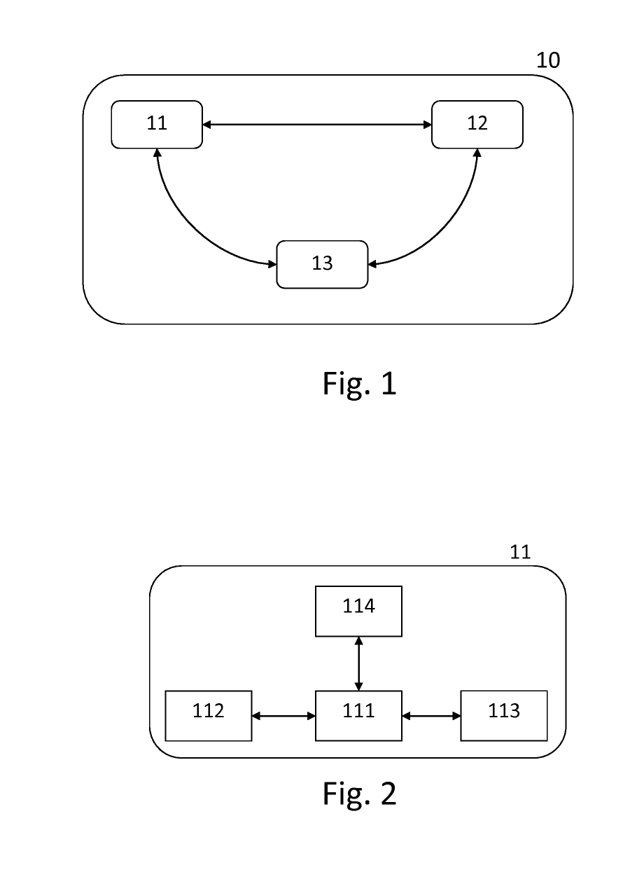

### DETAILED DESCRIPTION OF THE INVENTION

The present invention is a system 10 of electronic parking for cars as a replacement to the method commonly known as parking meter, among other similar methods, which, due to their technical characteristics, solves to a large extent the issues raised and known in the prior art. This system 10 comprises a fixed electronic device 11, a server 12, a user 13, optionally a portable electronic device 15 (not shown in the Figures) and optionally a system of prior art or kiosk 14 (not shown in the Figures). The fixed electronic device 11 is mounted on any corresponding place inside the vehicle, where it is expected that the car parks at a certain location and at a certain time. The fixed electronic device 11 has different signs that inform someone, operator or authority, as well as to the driver or user of the vehicle, if the vehicle is authorized to park, since there is a pre-authorization through a bonus or prepayment. Server 12 is the place where is stored a database with the information corresponding to the profile of each user 13 related to their respective device 11. The database contained in the server 12 is administered by any operator or service provider (not shown in the Figures); user 13 is who, in addition to driving and/or operating the vehicle, also carries a mobile wireless communication device, such as a mobile phone or smart phone, to keep himself informed about the status of his vehicle's parking and/or to make any request to the system 10. In the same manner, as a preferred embodiment, an element of the system 10 is a kiosk (not shown in the Figures), parking meter or system of prior art in operation, which, through compatible communication units, is adapted to receive and send information pertaining to their operation, such as information about identification, location, number of vehicles parked in its working area, information concerning the amount of vehicles that have not paid their parking time and/or information concerning the amount of vehicles whose paid time is about to run out. Kiosk 14 joins the present invention so that, by implementing the present invention, it does not affect the operation of the state of the art systems, but operate jointly.

Server 12 of system 10 is a station that receives and transmits information or data from one or a plurality of devices 11, one or a plurality of users 13, and/or one or a plurality of kiosks 14. The information is stored in their respective memory units, in order to have a record of everything that occurs in one or a plurality of systems 10. Server 12 focuses data concerning the profile of user 13 related to the device 11 found inside the vehicle, as well as a record of all vehicles that are parked. This profile may contain data from parking times, approvals, rejections, user identification, form of contact, type of vehicle, identification of the vehicle, bonuses, locations, penalties, etc., such that, once an operating cycle of system 10 is initialized or finished, the information relating to the corresponding elements in the system 10 is sent, such that they update their status, records and/or be informed.

If user 13 has ran out its available parking time, this user 13 may request more time to server 12, which is managed by the service provider, under the granting of any benefit or bonus to the operator of server 12. This series of requests is performed using wireless communication technology, where the user 13 uses his mobile wireless communication device, which may be his smart phone or mobile phone, to send the request and where such information is sent using an SMS text message, a phone call, an email, via communication over the Internet or any other media that contains information and can be electronically transmitted and processed. The server 12 also sends update information to the device 11 in order to update their memory records and/or update its status. In case of updating its status, this device 11 reports it onsite or in situ through lights and/or audible indicators so that user 13, any person, or authority, be aware of that status when the vehicle is or is not parked. Management of server 12 depends on some manager entity who will grant the authorization service of parking time for vehicles in any public or private, closed or open, parking lot from a pre-bonus, prepayment, income or predetermined credit. The rate of such pre-bonus, prepayment, income or credit may depend on or vary according to the geographical location of the vehicle (where the device 11 is installed), parking time, parking start time, parking season, type of vehicle, etc. Server 12 can be managed by one or a plurality of service providers, and a plurality of servers 12 can be administered by one or a plurality of service providers. Server 12 also has wireless communication means which are compatible with the wireless communication means used by the user 13 and device 11, such that bidirectional operational communication is ensured. This communication is bidirectional with any of the elements in the system 10 and where data or information transmitted will be encoded/decoded by each one of the elements in the system 10, in a manner such that each of these elements in the system 10 can identify and interpret securely this information and act accordingly, either by updating the database, displaying a text message or activating some light and/or sound indicator or any other particular operation in the system 10. In the same manner, the service provider of the server 12, by means of a person, may contact user 13 through the mobile phone of the user and/or device 11, using the microphone and speaker attached to the wireless communication unit 113 of device 11, in order to engage a voice conversation in case of problems or if any of the elements of the system 10 requested it. System 10 has the required equipment and security systems, hardware and software, to save the information of each user 13, each device 11 and server 12, as well as from other optional items, such that confidentiality is maintained in the service.

User 13 in the system 10 may be the person who owns or operates the vehicle to be parked and where the device 11 is mounted, and one or a plurality of these devices 11 may be mounted in one or a plurality of vehicles corresponding to a device 11 per vehicle for one or a plurality of users 13. This user 13 will start and terminate the operating cycle of the system 10 by activating any of the inputs of the device 11 such as, for example, by pressing a button which activates one of the inputs of the general input/output unit 114 of device 11, however, the start and end of the operating cycle is not limited only to be executed by the user 13, since a person of ordinary skill in the art will notice that the initialization or termination of such a cycle can be carried out automatically by stopping the vehicle, for a certain period of time, for some predetermined hours, by the geographical location of certain geographical coordinates, at the request of any of the elements of the system 10, at the request of any third party with certain privileges in the system 10, etc. In the same manner, the user 13 via a mobile wireless communication device compatible with the wireless communication used by the system 10, such as his mobile phone, can send or receive data. User 13 can receive notifications about the status of his parked vehicle, i.e., to know if he has or not sufficient time available to keep the car parked and act accordingly such as, for example, by leaving his vehicle parked in case of having authorized time, or by requesting more time to system 10 by transmitting, through the mobile wireless communication device, a request for more parking time for the vehicle where said device 11 is mounted and which is related to user 13, where such a application will be accepted according to a benefit.

FIG. 2 shows the fixed electronic device 11, which is mounted or installed in the vehicle that, at some point in time, will be parked in any street or public or private, closed or open, parking lot. Said device 11 has multiple modules or electronic units attached in order to have an operational communication between them and where these units can be placed inside or outside a single cabinet or container of the device 11 such that they can also be placed separate and/or in different places of the vehicle, depending on the performed and/or needed function, such as protection against vandalism, protection against the environment, to improve the range to certain radio frequency signals, and/or comfort for user 13. Environmental protection includes protection against wind, dust, water stream, flooding, etc. and may be under the international standard IP65, IP66, IP67, and/or IP68. As shown in the FIG. 2, these distinctive modules or units are the geographical location unit 112, such as a unit that uses GPS technology or any other technology that calculates the geographical location of any entity in all or part of the planet; a wireless communication unit 113 such as GSM technology or another with similar or superior characteristics; a brain 111 or controller unit that consists of a microcontroller, microprocessor, or programmable device, programmed to carry out the corresponding tasks of coordinating other units; a general output/input unit 114; and a memory unit (not shown in the Figures) which stores information corresponding to rates with respect to the geographical location of the device 11, digital maps of different geographical areas, identification data, operation log, bonuses record, relevant information of user 13, etc. In the device 11, the information corresponding to the authorized time that the user 13 has in order to park in a certain geographical location will be stored, since there is a record of the accomplished bonuses and transactions which, in addition, is constantly updated by the server 12. Device 11 is powered by a separate battery or other power source such as the energy source of the vehicle with the possibility of a backup battery. However, a person of ordinary skill in the art may notice that other units can comprise the device 11 without affecting the protected subject matter of the present invention, and these units can be the power source, power stages, etc. that are essential parts for the operation of any electronic device with these characteristics, however, is intended to note that all units, devices, etc., of the present invention, already have the basic elements in order to carry out their specific functions. Additionally, device 11 has records of geographical coordinates and/or maps of different areas configured and stored in internal memory, in order to compare these records with the current location of device 11 (and at the same time of vehicle) to identify the different areas and/or streets, which may have some special charge, restriction and/or privilege. The device is remotely reconfigurable and upgradeable. In the following, the units comprising the device 11 will be explained in detail:

The geographical localization unit 112 of device 11 is a unit used to locate the device 11, in any place where there is communication or within the operating range, from geographic coordinates calculated by said unit, and having all of the elements needed to operate in the corresponding environment, said elements can be, but not limited to: antennas compatible with working frequency, passive electronic elements, active electronic elements, electromechanical elements, electronic cards, specific electrical/electronic modules, programmable elements, cabinets against water immersion, energizing means, means of communication with other units, memory units, etc. However, a person of ordinary skill in the art may notice that these elements can be changed in name, in manufacturing methods, efficiency, size, etc. as technology develops and, however, applied specific function is maintained without affecting the protected subject matter of the present invention. This unit calculates the geographic location of device 11 and, therefore, that of the vehicle, and transmits such calculation at the time that some element of the system 10 requires it and/or automatically. Geographical location unit 112 can make use of any global or home system of navigation and/or geographical satellite positioning, or some other means available at the time to obtain the geographical coordinates of the entity in question with the corresponding precision, and which can be any of the technologies known as GPS, GLONASS, GALILEO, BEIDOU, or any other technology that allows to obtain the geographical location of objects in real-time. The geographical location unit 112 can be inside or outside of the same container cabinet holding device 11, such that this flexibility in the location of said unit permits the protection of the same against vandalism, theft, climate agent, improving the range of the radio frequency signal to engage wireless communication and/or comfort for user 13.

Wireless communication unit 113 of device 11 is a unit that wirelessly communicates device 11 with other entities and which has all the elements needed to operate in the corresponding environment, and these elements may be, but are not limited to: antennas compatible with the working frequency, passive electronic elements, active electronic elements, electromechanical elements, specific electrical/electronic modules, programmable elements, energizing means, modules for communication with other units, memory units, cabinets against water immersion, speakers, microphones, etc. However, a person of ordinary skill in the art may notice that these elements can be changed in name, in manufacturing methods, efficiency, size, etc. as technology develops and, however, the applied specific function is maintained without affecting the protected subject matter of the present invention. This unit maintains in bidirectional communication the device 11 with user 13 and server 12, among others. Wireless communication unit 113 can use any means or technology of wireless communication that meets the needs of the system 10. This technology of communication may be, but is not limited to these technologies: ZIGBEE or BLUETOOTH technologies, digital mobile telephony such as GSM, 3G, etc., with its derivatives GPRS, SMS, MMS, etc.; or any other technology that allows the sending and receiving of information such as voice and/or data to short, medium or long distance in real-time or in a wirelessly quick and expedient manner. Wireless communication unit 113 can be inside or outside the same container cabinet of device 11, such that this flexibility in the location of said unit permits the protection of the same against vandalism, theft, climate agent, improving the range of the radio frequency signal to engage wireless communication and/or comfort of user 13.

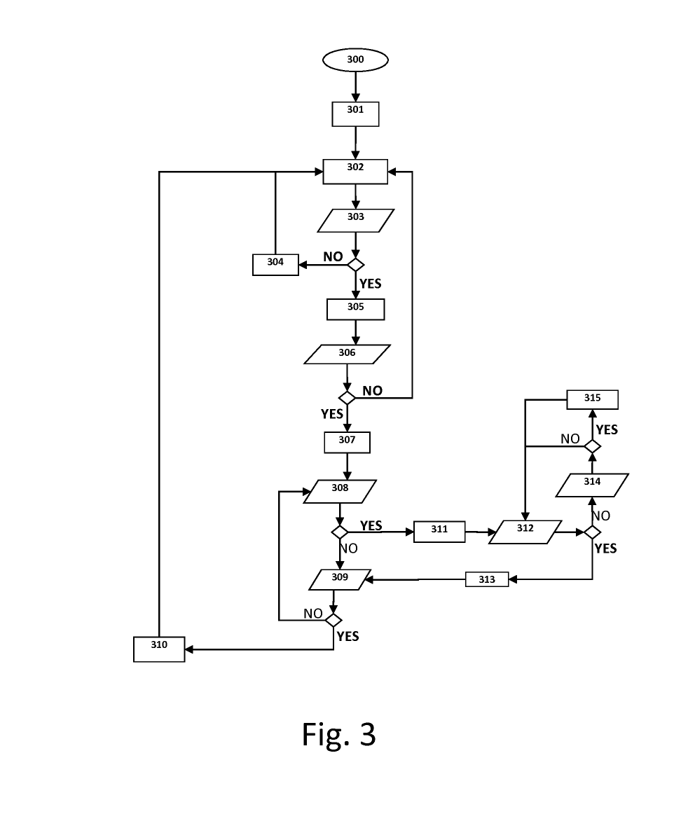

General output/input unit 114 of device 11 is a unit of interaction with the environment, immediate ambient or in situ, such as the user 13 or people close to the vehicle, which has all the elements needed to operate in the corresponding environment, these elements may be, but are not limited only to these items: passive electronic elements, active electronic elements, electromechanical elements, specific electrical/electronic modules, programmable elements, energizing means, modules for communication with other units, luminous indicators, cabinets against water immersion, speakers, buttons, microphones etc. However, a person of ordinary skill in the art may notice that these elements can be changed in name, in manufacturing methods, efficiency, size, etc. as technology develops and, however, applied specific function is maintained without affecting the protected subject matter of the present invention. This unit will have the means of notification, such as LEDs, buzzers, lights, etc., needed to inform in situ, through any sound message and/or any luminous indicator about the status of the system 10 corresponding to the vehicle where the device 11 is installed, concerning a user 13, such that any person or authority can know that status. In the same manner, this general inputs/outputs unit 114 will have digital and/or analogue inputs available to couple with different electrical/electronic components such as buttons, sensors, etc. which are required to start, restart or finish an operating cycle which is represented in the diagram in FIG. 3 corresponding to the method of operation where the elements of system 10 operate. The general input/output unit 114 has luminous indicators, such as LEDs. The luminous indicators of the general input/output unit may be several colors to facilitate identification of the status of the parked vehicle, where the device 11 is installed and connected. These colors may be green, yellow or red; however, a person of ordinary skill in the art may notice that the colors of the lights indicators may vary without affecting the protected subject matter of the present invention. As a preferred embodiment of the present invention, the green color is used when the operating cycle has been initiated, either manually or automatically, in the device 11 related to user 13, and this user has available or authorized time to park his vehicle in the corresponding area, so that the time available or authorized will begin to deduct as the time of the parked vehicle progresses. Red color is used when user 13 does not have more time available or authorized to continue parked or to park in a certain area. Yellow color is used when user has available time, but that time is not being used or is not being discounted, since the operating cycle has not been started, i.e., the vehicle is not parked but, however, has the authorization. The use of color luminous indicators provides the device 11 with different statuses, which are executed from that recorded in the internal memory unit of the device and/or from any updating from the system 10. These statuses are set to keep, by the use of these lights, informed or notified any operator, authority or the same user 13 about the condition of the vehicle, without having to ask the server 12 using a request or message, which reduces costs, time and promotes comfort of user 13. Such luminous indicators should have the characteristics needed in terms of lumens and power such that they can be distinguished by someone who is outside the vehicle. This such that the person who desires to know the status of the vehicle's parking knows if this vehicle has authorized time or if such time is ran out. The person may be any authority which, if it is confirmed that user 13 does not have time available or authorized by seeing that certain luminous indicator is on, such as the red, applies the corresponding sanction such as a monetary fine or any other penalty. General input/output unit 114 can be inside or outside of the same container cabinet of device 11, such that this flexibility in the location of said unit permits the protection of the same against vandalism, theft, climate agent, or for comfort and/or accessibility of the user 13.

The brain 111 or controller unit of device 11 is a unit that has the media or elements needed to manage, control or coordinate other units of the device 11 and also send the information corresponding to the other elements of the system 10 and/or to interpret the information received from these elements or units to perform any operation, update its status, etc. These elements operationally connected, comprised by the brain 111, may be, but are not limited only to these elements, passive electronic elements, active electronic elements, specific electrical/electronic modules, programmable elements, energizing means, means of communication with other units, memory units, etc. However, a person of ordinary skill in the art may notice that these elements can change their name, manufacturing methods, etc., as technology develops and, however, the applied specific function is maintained without affecting the protected subject matter of this application. This unit or brain 111 is in operational communication with all the units of device 11 such as the geographical location unit 112, wireless communication unit 113, general output/input unit 114, the optional Bluetooth unit, optional RFID unit or any other necessary unit such that, by adding it to the system 10, the functionality of such system is complete to solve the raised problems and which solves the present invention.

Each device 11 will be installed and related to the vehicle of the user 13 and also related to the user 13. So that this device 11 is installed in the related vehicle and said vehicle is operated and/or may be owned by user 13. Each car or transport vehicle will carry a particular device 11. The relationship of device 11 with the vehicle and the user 13 means that the device will record data of vehicle and user 13 on order to be identified, which are also transmitted to the server 12 also in order to record them in the database.

The location of the vehicle may be taken into account such that, in coordination with the user profile or data, once the vehicle is parked, a fee is determined in order to deduct the time based on this rate once the vehicle is parked. A free rate is possible where user 13 is in a particular area; such as close to its home or place of work or where said user 13 has certain privileges. If the authorized time is about to run out, the user 13 will be informed to request, without having to move, more time to the server 12, where is the database and the service provider, where such time will be granted according to a bonus, pre-bonus, credit or prepayment from same user 13 for the manager or service provider who manages the server 12. In the same manner, device 11 can store in its internal memory information from the most recent time in which device 11 was used, or the most recent time an operating cycle was run, such that device 11 maintains its status updated and informs the user 13 in situ with some light and/or sound indicator located on the general input/output unit 114, without the need for the device 11 repeatedly communicates with server 12, reducing costs and time. Once the vehicle is parked and the start button pressed, the operating cycle of such device 11 runs and the authorized time of user 13 begins to be deducted, which was made by a pre-bonus and also the geographical coordinates are sent to the system 10, in order to consider the just used space as busy and no longer be offered to some other user 13 in case of request for a search. Once completed the operating cycle, the status of device 11 will be updated by deducting the time used at the initial time. This calculation will update the status of the device 11, and it will be stored in the memory of the device 11, and it will be sent to the server 12 such that it also store it in its memory and update their records about the parking space which is now available. If, during the stage in which the authorized time is running, this time is close to ran out, the user 13 will be informed by sending him any notification or report of that status to his mobile communication wireless device so that this user 13 requests more time and/or goes to his vehicle and remove it from the parking lot, so that another user 13 can be informed that a parking space or place is about to become available or is already available.

Due to its information or internal records and received update information, the device 11 is constantly updated, so that this updating modifies or maintains certain device status such that the user 13, or some authority, knows it through the general input/output unit 114. Also, the device 11 knows the status of the profile of user 13, either because it is stored in its internal memory and/or receives updating from server 12. Said status of the profile of user 13 refers, among other information data, to if that user 13 can park free of charge, if he has privileges, or if he has authorized time to park in a certain area, since said user 13 made a pre-bonus, prepayment, credit, etc. This pre-bonus can be performed by different means such as through prepaid cards, bonus deposit in specific places, through the system of credit, by means of a charge to the account of its mobile receipt or any other account from another service, such that such pre-bonuses or prepayments are simple, comfortable, reliable and transparent to the user 13. All bonuses or prepayments are translated in authorized parking time for this vehicle. In the same manner, a plurality of service providers can be present through one or a plurality of respective servers 12, in order to have free competition in the service and, thus, favor prices for the customer or user 13. Device 11 can be lent, sold, rented, granted in bailment, etc. to the user 13 by the service provider who manages the server 12.

Sending of information data is performed through telephone calls, communication via the Internet, text messages, emails, voice messages and/or any other form of compatible electronic communication. The authorization time is based on a reward for the server manager from a bonus, pre-bonus, prepayment or any benefit for him, which can be realized from a contract. As a preferred embodiment, such reward will be deducted to the user 13 from any account or prepaid service related to the mobile phone with which the user 13 communicates with other elements in the system 10.

FIG. 3 shows a flowchart describing the process of operating the system 10. At step 300 the process begins where, in step 301 the elements in the system 10 are configured such that the user 13 and his vehicle are related to the device 11 and, at the same time, the information on the server 12 is recorded. The relationship is established from the transmission of data such as the name or identification number of the user, payments, credit available, type of vehicle, size of vehicle, vehicle identification, contact form of user 13, telephone number of device 11 and user 13, etc. Once the elements of the system 10 are configured, in step 302 the device 11 will be constantly getting information about its geographic location and, in step 303, the device 11 will be comparing that location with the information recorded in the same device 11 and/or recorded and shared by the server 12, in order to know what kind of privileges and/or features, such as previously authorized parking time, are encountered or implicit to said location, where, if in said step 303 it is determined that there are no privileges, credits, bonus or sufficient prepaid amount, and that the vehicle does not have sufficient authorized time so that the vehicle can park, in step 304 the device 11 will turn on or activate its red indicator light or luminous indicator (turning off the other indicator lights) in order to inform user 13 that parking is not possible, because of lack of credit or authorized time, and then is positioned again in step 302 where again and constantly will read the geographical location data from the geographical location unit 112. If at step 303 it is determined that the vehicle where the device 11 was installed has sufficient authorized time to park near or in the geographical location where it is located, then in step 305 the device 11 turns on its yellow light (turning off the other indicator lights) in order to inform the user 13 or the driver of the vehicle that has sufficient authorized time to park in the location where it is located or in the surroundings, so that, in step 306, the device 11 waits for an input signal indicating that the car or vehicle has been parked, so that, if the vehicle is not parked, then is returned to the step 302 to continue constantly reading the geographical location of the device 11. If at step 306 the vehicle where the device 11 is located is parked, such that the user 13 or driver can exit the vehicle and perform their activities, then in step 307 the indicator light green will be activated (deactivating the other indicator lights) and the authorized time will run, in order that, in step 308, either the device 11 and/or server 12, determines if the authorized time is about to run out according to preset tolerances so that, if that time is about to run out, then in step 311, the device 11 and/or server 12, informs the user 13 that his authorized time is about to run out, so that the user 13, if desires his car continues parked without any penalty, should request more time, by different means, such as through its smart phone or mobile phone, which will be granted from a prepayment or bonus which, as a preferred embodiment, is made discounting the corresponding amount of its mobile phone service account, so that in step 312 the server 12 waits said authorization and/or bonus from the user 13 such that, in the event that such authorization and/or bonus does not arrive in a predetermined period of time, in step 314 either the device and/or the server 12, determines if the time that was about to run out already has been completely ran out, in a manner that, if this time is not ran out, it is returned to step 312 to wait for this bonus and/or authorization of time. If at step 314 it is determined that time is completely ran out, then in step 315 such information will be sent to device 11 and server 12 such that both update its data and also the device 11 activates its red indicator light to communicates that the car is parked without corresponding permission or authorization, i.e., it does not have enough credits to keep parked, so a penalty or fine could be applied. Such sanction can be reported directly to any authority or operator, either from the device 11 and/or server 12, after the event of step 315. In the same manner, the penalty can be set forth when the authority, operator or watchman, such as a police officer that is inspecting vehicles parked near the area, identifies that the device 11 inside the vehicle has enabled or turned on its red light, so that the user 13, related to the vehicle, is sanctioned. If at step 308 it is determined that the authorized time is not about to run out, then in step 309 the device 11 waits for an input or message that informs that the parking cycle is finished, i.e., if the user 13 performed its activities, returns to the car and removes himself Such that, if said input indicating the end of an operating cycle is not detected, then it is returned to step 308 where it will be determined if the time is about to run out. If at step 309 an automatic or manual input is detected, such as pressing a button on the device 11 indicating that the operation cycle has finished, then in step 310 the device 11 will disable or turn off its green indicator light, will update its records according to the elapsed time and likewise will send the information to the server 12 and/or the user 13 to be subsequently positioned in step 302, which constantly reports about the geographical location of device 11.

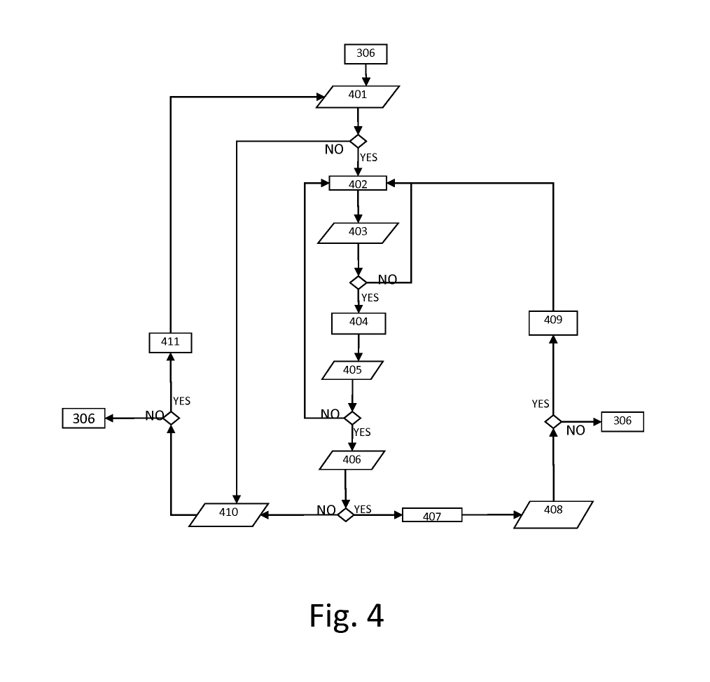

FIG. 4 shows a preferred embodiment of the described method where, before reaching step 306, in step 401 it is determined if user A requests a search for any available parking place or space close to its location, where if user A does not request such a search of step 401, since he prefers to search the space himself, then in step 410 the system will determine if spaces near or found by the user A have been reserved by any user B, and the determination of these spaces is made based on the data of the parking lot systems of the relevant prior art and/or system 10, such that, if user B has reserved this space close to user A, then the device 11 of user A will turn on its red indicator light and also, as a response to a request, the system 10 will not offer such a space to user A or to another user, except to user B, since it is temporarily reserved by said user B. If at step 410 it is determined that no one has reserved the parking space found by the user A, then the system is positioned in step 306, the main method above. If at step 401 the user requests a search for an available parking place or space, in step 402 the device 11 will send the geographical coordinates of its location to the server 12, so that, in step 403, based on that location, the available near spaces be determined If the system 10 does not find not available places, it will return to step 402 for the resending of geographical coordinates. If the system 10 finds one or a plurality of options of available spaces, in step 404 these options will be sent to device 11 and/or mobile phone of the user A in order to, in step 405, the user A selects the most advantageous option. If no option is selected by user A, the system 10 returns to step 402. If user A selects any option or parking space, in step 406 the system will ask the user A if he desires to reserve the space, such that if user A rejects the reservation, the system shall be positioned in step 410 above. If user A accepts the reservation, in step 407 the system 10, for a given time, will not offer the reserved space to any other user and also the statuses of other vehicles will be updated so that, when they come close to this already reserved space, the red indicator light will be turned on. In step 408, the system 10 determines if the reservation time has ran out and the user A has not parked his vehicle, so that if such time is ran out, then in step 409 the user A will be informed that the time has been expired, the statuses will be updated and it will be positioned in step 402. If at step 408 the reservation time is not yet ran out, then the system will be positioned in step 306 above.

Each vehicle will have assembled a device 11 of system 10. Vehicles, given the already explained requirements for prepayment and time authorization, may respectively be parked in any area allowed for this function, such as a street or public or private parking lot where, due to the geographical location of each vehicle, an accounting of the number of vehicles that are parked on the street at any given time will exist and also a record of its location in real-time, in which the accuracy will depend on the global satellite positioning technology used by the geographical location unit 112, in such a way that, by making a preliminary analysis to find out the maximum number of vehicles that can be parked on certain streets, the system 10 will be aware of the number of places available for parking on the street at one point so that, in view of a request, along with geographic location data, from any user 13, who would like to know if there is any available parking space nearby the place where that user 13 is or toward that user 13 goes, then the program 10 will calculate exactly where is that available parking space and so inform the user 13 such that he moves to the parking place or space. The way in which user 13 is notified is by means of communication means already described, i.e., by means of a text message, phone call, e-mail, message communication over the Internet or through electronic equipment of navigation by GPS, bound to device 11, which can guide the user 13 along its travel until it reaches the geographical location of available parking, since it has maps, references and technology for such a task. The exact site of the available parking space that system 10 calculates for the user 13 and which will subsequently be informed, may depend on the location of the user, the user preference in case of request a street preferred by the user 13, type of car, the dimensions of the car, the estimated parking time or any other justification conducive to any of the elements in the system 10. These preferences will be predefined or can be communicated by user 13 to system 10 by means of communication already described. System 10 can also link and/or communicate with parking meter systems or parking lots, which are another technology unrelated to the present invention and/or belonging to the prior art, but which are technically adapted to share their data with the system of the present invention. Such adaptation may be the coupling of an encoder-decoder, as well as a communication unit compatible with the system of the present invention. Such prior art systems are currently in use, but likewise have a record of cars or vehicles that are parked in their working areas, such that they know the amount of vehicles parked in these same areas so, in view of the transmission of its data, perform the corresponding calculation of how many vehicles using the technique of the present invention are found parked in some street and how many vehicles outside the present invention also are parked in the same area and, since the maximum number of vehicles that can be parked in the same area is known under a previous analysis, the following mathematical formula can then be applied to know how many parking spaces are available in that area:

Pd=Pmax−(Pi+Pa)

Where

Pd: Parking spaces available in an area

Pmax: Maximum capacity of vehicles properly parked in the spaces of this area

Pi: Number of vehicles properly parked in the spaces of this area that, in addition, use the system of the present invention

Pa: Number of vehicles properly parked in the spaces of this area that does NOT use the system of the present invention or that use the kiosk as a method of parking

This is performed in order to take into account one or a plurality of vehicles that do not still implement the system 10, but they are parked in these areas. So the system 10 can be integrated to existing parking meter systems, such as electronic kiosks, where such systems are adapted to have communication or send/receive information to/from the system 10. Communication with these parking systems already developed is bidirectional, in order that both systems are aware of their status, requests, etc. and operate normally taking into account the needs of both parties.

Also computer programs on different electronic devices are created to facilitate and/or automate functions in the system 10 where, to the device 11, is joined a unit of short-range wireless communication such as Bluetooth technology, such that the device 11 communicates with any electronic device compatible with this technology, which has the ability to offer the service of navigation by satellite global positioning. This electronic device contains maps, images and references necessary for such a task, where device 11 will send information concerning the location of the available parking space found by the system 10 and/or selected by user 13, since the system 10 knows the state and location of all vehicles that contain a device 11 and vehicles that are parked in the parking systems of the prior art. The system of the present invention is in operational communication with the parking systems of the prior art in order to calculate the amount of parking spaces available at the corresponding place and time. Parking systems can be, for example, the different parking kiosks found in every street or parking meter systems. This software, also known as applications, can be applications to search for a parking space from geographical coordinates received, transmitted and interpreted by an electronic device that uses the global positioning system or GPS, which will be called electronic device of navigation by satellite, and that will guide the user 13 by visual and/or audible messages, along the route calculated to find the available parking space found by the system 10 for that user 13, which may be a plurality of places of available parking spaces, where user 13 would select one of them, either directly in the electronic device for navigation by satellite or directly with a message or communication with the server 12. Under this model, it is possible that the system 10 can reserve the parking place or space available selected by the user 13 for a determined time, so that system 10, while the reservation time is active, will not given to no one else said already selected parking space. The parking reservation service can operate or not under an additional bonus by the client or user 13 to system 10. For example, in the event that a user B tries to park its car in a place that has been reserved for a user A, the user B may be informed that said parking space is reserved. The notification can be by visual and/or audible means, such as by using one of the indicators of the general input/output unit 114 of device 11 where, as a preferred embodiment, the red indicator light will be activated when user B is near said available parking space already reserved for user A. The system 10 can do an indefinite reservation of a parking space for users who have certain privileges, where such privileges may be an established prior agreement between the user-provider of the service, a monthly income, that the user lives or works near or in the vicinity where the parking space is, so that the space is indefinitely or temporarily reserved.

The authority, supervisor or person that applies sanctions to vehicles whose authorized time has run out, can carry a portable electronic device 15 (not shown in the Figures), which, in addition to being configured and in communication with the elements of the system 10 to apply a sanction or penalty, can disable the parking space where the vehicle is, which has ran out its parking time and continues parked, such that said parking space, once disabled, is not offered by the system 10 to any other user 13, in addition to apply a penalty to the user of the vehicle. The portable electronic device also has a unit of wireless communication, a unit of geographic location, a controller unit and optionally a RFID unit, similar to the units of the fixed electronic device 13, to communicate and send information concerning certain vehicle in a certain status.

In the same manner, if in view of a search there are not available spaces or in view of a user's request, the system 10 can offer parking spaces in private parking lots, in such a way that these private parking lots may benefit from the promotion that the system 10 makes. The benefit can occur according to a bonus to the service provider.

The system 10 can also support an alarm system where, if the parked vehicle (where the device 11 is installed), is violated in any way, then said violation will be identified by the corresponding sensors, and where the user 13, server 12 and/or any authority or representative of the law, will be informed to take measures or proceedings. The violation of the vehicle can be detected from different sensors of presence, movement, flood, etc. installed on the vehicle in the appropriate places, which will detect any disturbance in the atmosphere of the vehicle such as the opening of a door, the breaking of any window, heavy rain, movement inside the car, gasoline theft, theft of a tire, etc. These sensors will give information to the device 11 through the general input/output unit 114, which in turn notifies the brain 111 to interpret this information. In the same manner, where the geographical location unit 112 detects that the vehicle has been moved or is moving without any prior authorization, then the alarm will be turn on reporting the state of alarm, the new location, time, elapsed time, etc. to any of the elements of the system 10 and, likewise, to device 11, which can perform some predetermined operation, such as turn off the vehicle, activate an audible and/or visual alarm, etc. where the user 13, through its mobile wireless communication device, may be informed and, in addition, cancel, increase and/or reduce such operations.

It will be apparent to those skilled in the art that several modifications and variations can be made in the present invention without departing from the scope or spirit of invention. Other embodiments of the invention will be apparent to those skilled in the art from the consideration of the specification and practice of the invention described herein. It is intended that the specification and examples are considered only as exemplary, with a true scope and spirit of the invention being indicated by the attached claims.

1. A wireless electronic system for the authorization of parking time, search and monitoring of available parking spaces in real-time for vehicles and in a plurality of areas comprising:
a user, who drives the vehicle to be parked in an available space under authorization, wherein the user carries a portable wireless communication device for receiving reports and/or make requests to the system;
a server, wherein there is a database where the information corresponding to each user and each parked vehicle recorded in the system is concentrated, wherein said server shares information with the other elements of the system through compatible wireless media;
an electronic device installed in each vehicle, wherein said device can calculate, in real-time, the geographical location of said vehicle to process such information, change its status and to report it wirelessly to the user, the server and/or some parking system of the prior art, wherein said electronic device interacts with its immediate ambient through outputs that indicate its current status on site and inputs to receive user requests;
one or a plurality of systems of the prior art, adapted to be compatible with the system, wherein such prior art systems send and receive information concerning the number of vehicles that are parked in its working area, as well as the status of each vehicle.

2. The system in accordance with claim 1, wherein the authorization of parking time for a vehicle is performed via a smart phone or mobile phone.

3. The system in accordance with claim 1, wherein the authorization of parking time for a vehicle of a user is performed according to a benefit to the service provider charged to the smart phone or mobile phone account of user.

4. The system in accordance with claim 1, wherein the search for available parking spaces for a vehicle of a user is performed according to a benefit to the service provider charged to the smart phone or mobile phone account of user.

5. The system in accordance with claim 1, wherein for a specified or unspecified period, the system can reserve available parking spaces for users who solicited or not said reservation.

6. The system in accordance with claim 5, wherein the reservation can be performed based on the area in which the vehicle is or based on where the vehicle is directed.

7. The system in accordance with claim 1, wherein the system can condone or reduce the benefit to the service provider in the event that the vehicle of user is located in a particular area, such as near the home or workplace of the user or the user has pre-established privileges.

8. The system in accordance with claim 1, wherein the system supports an alarm system.

9. System according to claim 1, wherein the system is compatible with software specific to this system, known as applications, implemented in portable electronic devices.

10. The system in accordance with claim 1, wherein the system has adequate means to maintain confidentiality and/or safeguard the particular information corresponding to each element of the system.

11. The system in accordance with claim 1, wherein the system is able to communicate and exchange information with the parking systems of the prior art.

12. The system in accordance with claim 11, wherein parking of systems of the prior art are parking meter systems and/or kiosk systems.

13. The system in accordance with claim 1, wherein the vehicles are parked in streets or avenues of a city.

14. The system in accordance with claim 1, wherein the status of a vehicle, that uses the system of the present invention, is informed in real-time, in situ and/or wirelessly, through an electronic device.

15. The system in accordance with claim 1, wherein an authority or supervisor can know the authorized or unauthorized status of vehicles, either in situ or remotely.

16. The system in accordance with claim 15, wherein the authority that monitors the status of vehicles has a portable electronic device to sanction vehicles and/or disable parking spaces such that they are not offered in view of a search request.

17. The system in accordance with claim 1, wherein the system calculates, in real-time, how many are and where is one or a plurality of available parking spaces in a certain area.

18. The system in accordance with claim 1, wherein the system can inform a user about the location of one or a plurality of busy parking spaces that are close to empty.

19. The system in accordance with claim 1, wherein the portable wireless communication device of the user is a smart phone or mobile phone.

20. The system in accordance with claim 1, wherein the operating cycle of the system can be activated manually or automatically.

21. The system in accordance with claim 20, wherein the automatic manner is performed by detection of any sensor, location of any geographical coordinate, by turning off the vehicle, by starting the vehicle and/or by stopping the vehicle.

22. The system in accordance with claim 1, wherein the system can reserve indefinitely a parking space for a user with privileges.

23. The system in accordance with claim 22, wherein privileges can be giving a corresponding benefit, a contract drawn up between user-service provider, that the user resides near the parking space or that the user works near the parking place.

24. The system according to claim 1, wherein the system reports on available parking spaces in private parking lots.

25. The system in accordance with claim 1, wherein the system can be made compatible with equipment of satellite navigation to guide user on his travel.

26. An electronic device fixed on a vehicle to calculate the geographical location of said vehicle, such that based on said location, updates its status and sends this information to an electronic wireless system for the authorization of parking time, search and monitoring of available parking spaces for vehicles in real-time and in a plurality of areas, the device comprising:
a unit of geographic location that calculates, in real-time, the geographic coordinates of a vehicle to identify the area where the vehicle is, and process said information to change its status and/or transmit it;
a unit of wireless communication that communicates wirelessly with the elements of a wireless electronic system for the authorization and search for available car parking spaces to share information concerning such a system;
a general input/output unit for the interaction of the device with its immediate ambient through inputs such as buttons to receive requests and/or outputs such as indicator lights to report the status of the device in situ;
a controller unit or brain that coordinates the operation and communication of all units of the device through programmable and programmed electronic elements for such a task.

27. The electronic device in accordance with claim 26, wherein the device is equipped with a Bluetooth unit to share information with compatible satellite navigation electronic equipment.

28. The electronic device in accordance with claim 26, wherein the units comprising the device may be inside or outside a container cabinet.

29. The electronic device in accordance with claim 26, wherein the inputs that the device receives are digital and/or analog signals emitted by sensors.

30. The electronic device in accordance with claim 29, wherein the inputs are used to activate the operating cycle of the device.

31. The electronic device in accordance with claim 29, wherein the inputs are used for an alarm system of the vehicle.

32. The electronic device in accordance with claim 26, wherein the energy source of the device is present through the battery of vehicle or through an independent battery.

33. The electronic device in accordance with claim 26, wherein the device is equipped with an RFID unit to be easily identified wirelessly at close range.

34. The electronic device in accordance with claim 26, wherein the luminous indicators have the means to be noticed and identified by the user and/or an authority.

35. The electronic device in accordance with claim 26, wherein the luminous indicators are LEDs.

36. A method of operation for a wireless electronic system for the authorization of parking time, search and monitoring of available parking spaces for vehicles in real-time and in a plurality of areas, comprising the steps of:
A. obtaining information about the geographical location of said vehicle;
B. determining whether there is available authorized time for such a vehicle in the area in which it is, such that if it is determined that there is no authorized time, the red indicator light is turned on and is returned to step A. If it is determined that there is authorized time, the yellow indicator light is turned on to inform the driver of said vehicle about said status;
C. waiting for an input signal indicating that the vehicle has been parked, such that if the vehicle is not parked, then will be return to step A. If the vehicle is parked, the green indicator light is turned on and the authorized time begins to be deducted;
D. determining if the authorized time is about to run out;
E. if the time authorized of step D is not about to run out, determining if the operating or parking cycle has been completed;
F. if the operating cycle has not been completed, returning to step D;
G. if the operating cycle of step E has been terminated, activating the green indicator light, updating records in all elements of the system and returning to step A;
H. if the time authorized of step D is about to run out, the user will be informed that status to take the appropriate measures such as request more time;
I. determining whether the user has requested more time and this has been granted;
J. if at step I it was determined that there is more time authorized, informing and updating records and returning to the step;
K. if at step I it is determined that no more time in a given period has been authorize, determining if the time which was about to run out already ran out completely;
L. if at step K time has not been run out fully, informing and updating records of the elements of the system and returning to step I;
M. if at step K it was determined that time is ran out completely, sending such information to the elements of the system to update their data and also activating the red indicator light.

37. The method in accordance with claim 36, wherein as a preferred embodiment after step B, follows the steps of:
N. determining if the user has sent a request for search for an available space,
O. if there is a request of search for an available parking space, sending the geographical coordinates of the place where the vehicle is to make the search in that area or sending the coordinates of the area where the user desires to park;
P. looking for the available parking space based on received geographical coordinates;
Q. if at step P there is no available parking space, returning to the step O;
R. if at step P is found one or a plurality of available parking spaces, notifying the options to the user in order to select an option;
S. if at step R the user does not select any parking place or space available, returning to step O;
T. if at step R the user selects an available parking space, asking if the user desires to reserve the available space;
U. if at step T the user reserves said parking space, the system will not offer this place to any other user and will also update records, for a given time;
V. determining if the specific time for reservation has concluded;
W. if the reservation time has not terminated, going to step C of the main method;
X. if at step V the reservation time has terminated, informing to the user and updating records;
Y. if in the step T the user does not desire to reserve said available parking space, determining if the available parking space has recently been reserved by some other user;
Z. if at step Y the available parking space has not been reserved by any user, going to step C of the main method;
A2. if at step Y the available parking space has been reserved by any other user, returning to step N;
B2. if at step N the user does not request the search for an available parking space, going to step Y.

38. A portable electronic device for an authority or supervisor who monitors a wireless electronic system for the authorization of parking time, search and monitoring of available parking spaces for vehicles in real-time and in a plurality of areas to punish users, disable parking spaces and/or enable parking spaces, the device comprising:
a unit of geographic location that calculates in real-time the geographic coordinates of a parking space where a vehicle is parked;
a unit of wireless communication that communicates wirelessly with the elements of a wireless electronic system for the authorization of parking time, search and monitoring of available parking spaces for vehicles in real-time and in a plurality of areas to share information concerning such a system;
a controller unit or brain that coordinates the operation and communication of all units of the device through programmable and programmed electronic elements for such a task.

39. The electronic device in accordance with claim 38, wherein the device is equipped with an RFID unit for wireless identification of vehicles.
